(19) United States
(12) Patent Application Publication
(10) Pub. No.: US 2012/0147497 A1
(43) Pub. Date: Jun. 14, 2012

(54) MAGNETIC RECORDING MEDIUM AND MAGNETIC RECORDING APPARATUS

(75) Inventor: Haruhiko IZUMI, Tokyo (JP)

(73) Assignee: Kabushiki Kaisha Toshiba, Tokyo (JP)

(21) Appl. No.: 13/323,423

(22) Filed: Dec. 12, 2011

(30) Foreign Application Priority Data
Dec. 13, 2010 (JP) 2010-277390

(51) Int. Cl. G11B 5/127; G11B 5/82

(52) U.S. Cl. 360/110; 360/135; G9B/5.04; G9B/5.293

(57) ABSTRACT

According to one embodiment, a magnetic recording medium includes: a data region including a plurality of first magnetic dots disposed at specific positions for recording data; and a servo region including a plurality of second magnetic dots disposed at specific positions for identifying the position of the first magnetic dots, wherein an address pattern in the servo region is subdivided in the radial direction.

### CROSS REFERENCE TO RELATED APPLICATION(S)

The application is based upon and claims the benefit of priority from Japanese Patent Application No. 2010-277390 filed on Dec. 13, 2010, the entire contents of which are incorporated herein by reference.

### BACKGROUND

1. Field

Embodiments described herein relate to a magnetic recording medium and a magnetic recording apparatus.

2. Description of the Related Art

With respect to methods for subdividing servo patterns in bit-patterned media (BPM), the coercive force due to demagnetizing fields in large surface area patterns is reduced since a magnetic layer of the BPM is a non-granular continuous layer. Magnetic reversal sometimes occurs due to shock, such as head contact, even when a servo pattern magnetic direction has been initially magnetized.

A known countermeasure therefore is to make the surface areas smaller by subdividing the servo pattern, thereby securing coercive force. For example, there is a description in JP-A-2010-55720 of an example of shifting division position in the radial direction when subdividing a preamble and burst pattern.

However, while there is a need for a countermeasure to reproduction waveform amplitude deterioration caused by servo pattern division there is no known method for achieving such a goal.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a schematic diagram illustrating an exemplary embodiment of a magnetic recording apparatus equipped with a magnetic recording medium;

FIG. 2A and FIG. 2B are schematic plan views illustrating sector configuration on the magnetic disk medium of the exemplary embodiment provided in the magnetic disk apparatus;

FIG. 3A is a schematic plan view illustrating a surface of the magnetic disk medium of the exemplary embodiment;

FIG. 3B is a schematic configuration diagram illustrating magnetized states in a data region and a servo region of the magnetic disk medium of the exemplary embodiment;

FIG. 4A to FIG. 4C are explanatory diagrams of an actual example of an address pattern subdivision method of the exemplary embodiment;

FIG. 5 is an example of address reproduction rules in the exemplary embodiment;

FIG. 6 is an enlarged example of an address pattern subdivision method of the exemplary embodiment;

FIG. 7 is a block diagram of a servo signal demodulation circuit in the magnetic disk apparatus of the exemplary embodiment; and

FIG. 8 is an operation timing chart of the servo signal demodulation circuit in the magnetic disk apparatus of the exemplary embodiment.

### DETAILED DESCRIPTION

Explanation follows regarding an exemplary embodiment.

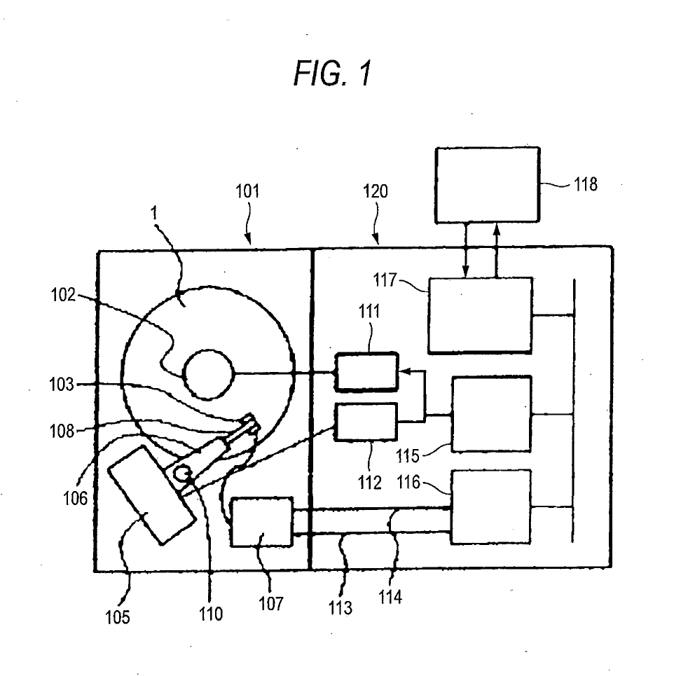

Explanation follows regarding a first exemplary embodiment, with reference to FIG. 1 to FIG. 5 and FIG. 8. FIG. 1 is a schematic configuration diagram illustrating an exemplary embodiment of a magnetic recording apparatus equipped with a magnetic recording medium, described later. The magnetic recording apparatus shown in FIG. 1 includes a disk shaped magnetic recording medium (magnetic disk medium) 1 (the magnetic recording apparatus equipped with a magnetic disk medium is referred to as a magnetic disk apparatus below).

The magnetic disk apparatus includes a disk enclosure 101 and a circuit board 120.

The disk enclosure 101 is a device that densely housing components such as the magnetic disk medium 1, an actuator 105 that includes a spindle motor 102, a magnetic head 103 and a voice coil motor (VCM) (not shown in the drawings), a head gimbal assembly 108, a carriage arm 106, a shaft 110, and a head amplifier 107. The magnetic disk medium 1 is mounted to the spindle motor (SPM) 102. The magnetic head 103 includes at least a recording (write) element (not shown in the drawings) for recording magnetic data on the magnetic disk medium 1 and/or a reproduction (read) element (not shown in the drawings) that acts to extract magnetic data recorded on the magnetic disk medium 1 as an electrical signal. The write element includes, for example, a write coil, a main magnetic pole layer, and an auxiliary magnetic pole layer. The write coil functions to generate magnetic flux. The main magnetic pole layer functions to collect the magnetic flux generated in the write coil, and throw the magnetic flux out towards the magnetic disk. The auxiliary magnetic pole layer functions to circulate the magnetic flux thrown off from the main magnetic pole layer through the magnetic disk. Examples of a read element include a magnetoresistive (MR) element. The magnetic head 103 is mounted to the head gimbal assembly 108 so as to be disposed facing the magnetic disk medium 1.

Various magnetic storage media, described later, can be employed as the magnetic disk medium 1. The end portion of the head gimbal assembly 108 not mounted with the magnetic head 103 is fixed to the distal end of the carriage arm 106. The carriage arm 106 can be made to perform a swinging movement about the shaft 110 as the axis of rotation using the VCM. The magnetic head 103 can be scanned in a substantially radial direction over the magnetic disk medium 1 using this swing movement. By positioning the magnetic head 103 at a desired recording track on the magnetic disk medium 1 the magnetic head 103 can write data to recording bits arrayed along a recording track on the magnetic disk medium 1, or can read data from the magnetic disk medium 1. The head amplifier 107 performs the role of recording on the magnetic disk medium 1 by flowing a current based on a recording signal 113 through the write element mounted to the magnetic head 103, or performs the role of converting magnetic data of the magnetic disk medium 1 detected by the read element of the magnetic head 103 into a reproduction signal 114,

The circuit board 120 includes: a read channel 116, a micro processor unit (MPU) 115, a spindle motor (SPM) driver 111, a voice coil motor (VCM) driver 112 and a disk controller 117. The read channel 116 either decodes the reproduction signal 114 (servo signal or data signal) from the head amplifier 107 and converts the signal into digital data, or performs the role of converting data designated for recording from the disk controller 117 into a recording signal 113 for driving the head amplifier 107.

The MPU 115 drives the VCM driver 112 based on digital data (servo data) of the servo signal decoded by the read channel 116 to perform positional control on the magnetic head 103, or drives the SPM driver 111 to perform rotation control of the magnetic disk medium 1.

The disk controller 117 instructs the MPU 115 to perform positioning of the magnetic head 103 according to a recording or reproduction command from a host computer 118, and performs the role of addressing the magnetic head 103 to the magnetic disk medium 1. The disk controller 117 transmits and receives digital data for recording or reproduction to and from the read channel 116, and operates to return the result to the host computer 118.

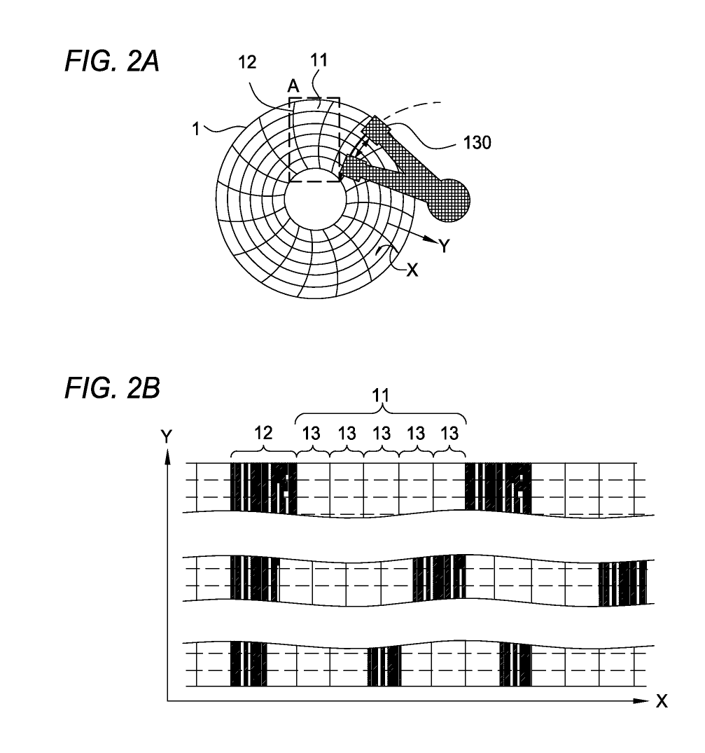

Explanation now follows regarding a magnetic recording medium, with reference to FIG. 2A and FIG. 2B.

FIG. 2A is a schematic plan view illustrating a sector configuration of a magnetic disk medium of an exemplary embodiment provided to a magnetic disk apparatus. FIG. 2B is an enlargement of area A in FIG. 2A. In the drawing the surface of the disk is shown with the circumferential direction of the disk along axis X, and the radial direction of the disk along axis Y (this also applies to other drawings below).

Generally data regions 11 and servo regions 12 are disposed on the magnetic disk medium 1 alternately along the circumferential direction. Namely, the servo regions 12 are disposed intermittently along strip shapes of substantially circular circumferences having the center of the magnetic disk medium 1 at substantially at the center. The data regions 11 are disposed at portions where there are no servo regions 12 disposed along the strip shaped substantially circular circumferences.

The data regions 11 are regions for storing data. Data sectors 13 are storage regions for recording or reproduction in the data regions 11 disposed at fixed length (track pitch) periods along the circumferential direction. Magnetic dots (not shown in the drawings) are included in the respective data sectors 13. The shape and the layout of magnetic portions provided in the data regions 11 is called the data pattern.

The servo regions (servo sectors) 12 are provided in order to identify the position of the magnetic dots included in the data regions 11 (and in particular their position in the disk radial direction). The servo regions 12 include magnetic dots of various shapes and layouts, as described later. The shape of the servo regions 12 are circular arc shapes that form the head access path in the magnetic disk apparatus, with the circumferential direction length of the servo regions formed so as to increase in length proportionally to their radial positions. The shape and layout of the magnetic dots provided in the servo regions 12 is called the servo pattern.

When the magnetic disk medium is in a rotating state the magnetic head 103 acquires positional data of the magnetic head 103 by the magnetic head 103 reading a reproduction signal formed by the magnetic dots included in the servo regions 12. The magnetic head 103 is positioned relative to the tracks according to the positional data acquired by the magnetic head 103, enabling recording or reproduction to be performed to the magnetic region in the desired position on the data regions 11.

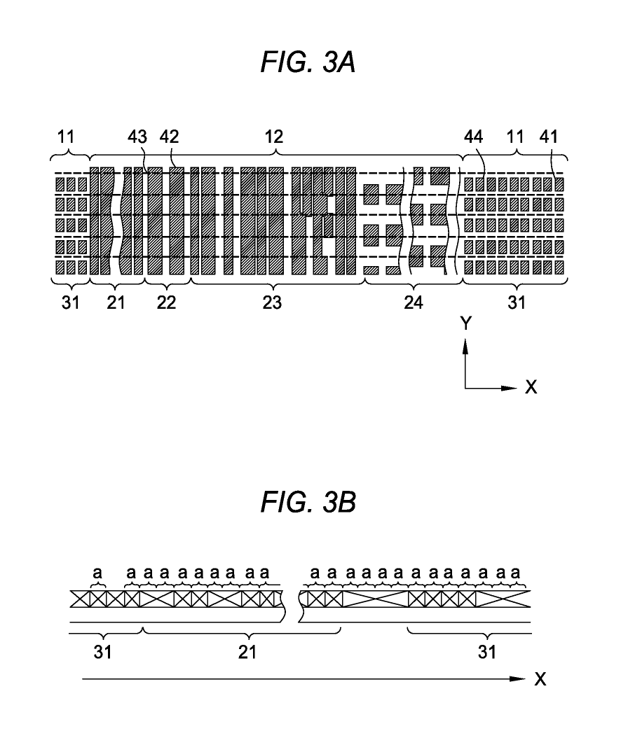

FIG. 3A is a schematic plan view illustrating the surface of a magnetic disk medium of an exemplary embodiment, and FIG. 3B is a schematic configuration diagram illustrating a magnetized state of a data region and a servo region of a magnetic disk medium of an exemplary embodiment. The magnetic recording medium of the exemplary embodiment has data region magnetic dots and servo region magnetic dots formed in specific positions, in other words the magnetic recording medium is a patterned medium.

Plural of the magnetic dots (first magnetic dots) 41 are disposed at specific positions in the data regions 11. Data bits a are formed by scanning the magnetic head over the first magnetic dots 41 inside the magnetic disk apparatus. Disposed in “specific positions” refers to there being a fixed relationship to adjacent dots, namely the magnetic dots are disposed intermittently along the circumferential direction (the track direction). Normally the first magnetic dots are disposed with a fixed separation to adjacent first magnetic dots in the circumferential direction. An example of disposing in specific positions is a structure of magnetic dots, described later, formed with a nanoimprint method or photolithographic method. In contrast thereto, an example of not being disposed in specific positions is as an irregular structure of magnetic dots formed by dispersing magnetic particles in a non-magnetic body (called a granular structure).

The first magnetic dots 41 are, for example, formed from a polycrystalline ferromagnetic body, such as CoCrPt. A non-magnetic body 44 such as silica, alumina or air is disposed around the periphery of the first magnetic dots 41. Adjacent pairs of first magnetic dots 41 are isolated from each other by the presence of the non-magnetic body 44. The first magnetic dots 41 are respectively imparted with the desired magnetic field by the recording element in the magnetic disk apparatus. The magnetization of the first magnetic dots 41 due to the magnetic field is held in a state facing in the desired direction. The first magnetic dots 41 can thereby store magnetic data. The reproduction element reproduces the magnetic data recorded in the first magnetic dots 41. Different hatching is employed according to the directions of magnetization in FIG. 3A and FIG. 3B. Magnetization of the magnetic dots faces in a normal direction to the surface of the medium in a magnetic disk medium utilizing a perpendicular magnetization recording method.

The servo regions 12 include magnetic portions 42 and non-magnetic portions 43. The magnetic portions 42 include both plural magnetic dots (second magnetic dots) (not shown in the drawings) and non-magnetic bodies (not shown in the drawings) disposed so as to wrap around the magnetic dots. The second magnetic dots and the non-magnetic bodies are described later. In patterned media, generally magnetization is in the same direction for all of the second magnetic dots. The non-magnetic portions 43 are formed from non-magnetic bodies. Data bits a are respectively formed according to the magnetization and non-magnetization by scanning the magnetic head over the magnetic portions 42 and the non-magnetic portions 43 in the magnetic disk apparatus.

The servo regions 12 in the magnetic disk medium can be classified according to function of use into synchronization signal generating portions 21, synchronization signal detection portions 22, address portions 23, and precision position detection portions 24.

The synchronization signal generating portions 21 act to regulate the amplification ratio of a signal amplifier and make the amplitude uniform prior to acquiring the servo data, and to generate a sampling timing of an Analog to Digital (A/C) Converter clock signal. The synchronization signal generating portions 21 are continuous in the radial direction in a range over the whole or part of the span from the inner periphery of the medium to the outer periphery, and include magnetic portions formed at fixed intervals around the circumferential direction.

The synchronization signal detection portions 22 are characteristic patterns indicating the start of servo data. The synchronization signal detection portions 22 are continuous in the radial direction in a range over the whole or part of the span from the inner periphery of the medium to the outer periphery, and include either a single magnetic portion of longer bit length along the circumferential direction than the synchronization signal generating portions 21 or plural magnetic portions for generating a default code of plural bit length.

The address portions 23 are ID patterns indicating the track number and the sector number for each of the servo frames. In the magnetic recording apparatus the track position for positioning the magnetic head is indicated. The address portions 23 include magnetic bodies and at circumferential direction positions for indicating the sector number the address portions 23 are continuous in the radial direction in a range over the whole or part of the span from the inner periphery of the medium to the outer periphery. At circumferential direction positions for indicating the highest order digits of the track number the address portions 23 are continuous in the radial direction in a range over the whole or part of the span from the inner periphery of the medium to the outer periphery. The address portions 23 are intermittent in the medium radial direction at circumferential direction positions for indicating the lower order digits of the track number.

The precision position detection portions 24 are provided in the magnetic recording apparatus for detecting displacement data of the position of the magnetic head from track center. Examples of the precision position detection portions 24 include an arrangement in which one or more types of magnetic pattern of particular shape and/or layout in the circumferential direction are disposed such that the respective magnetic patterns have even separations for each track in the medium radial direction. Another example of the precision position detection portions 24 is an arrangement across plural tracks in which the length direction is not parallel to the radial direction of the disk, to give a band shaped magnetic pattern (referred to below as a diagonal band shaped magnetic pattern).

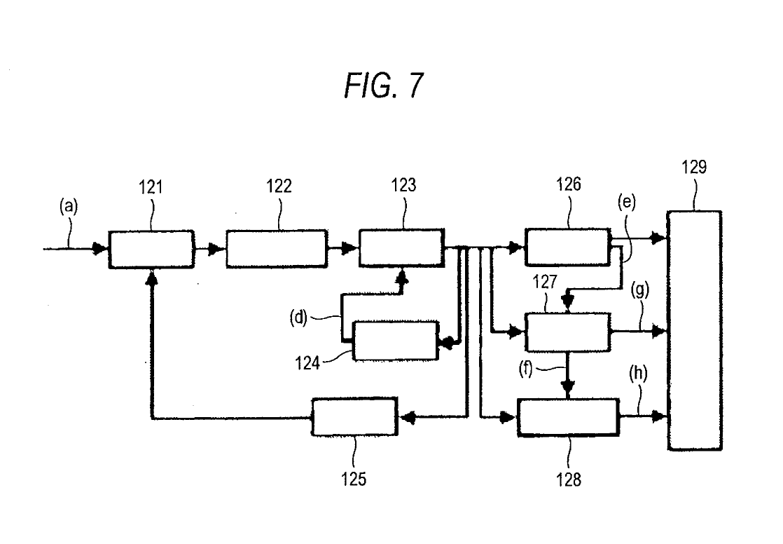

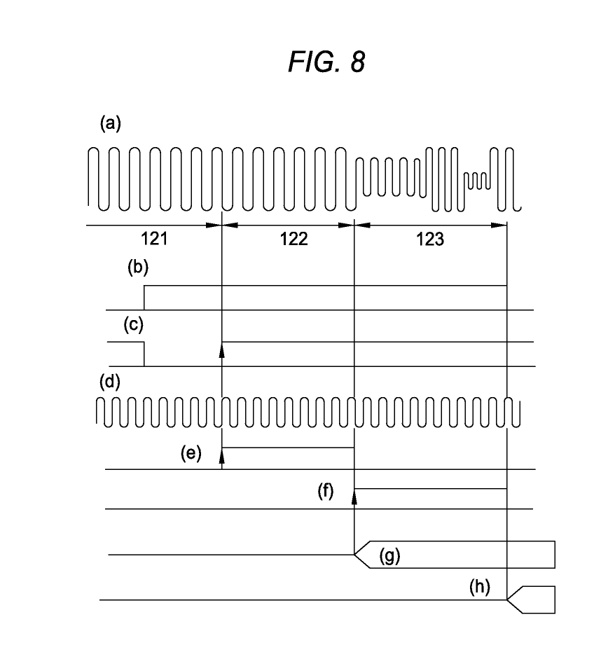

FIG. 7 is a block diagram representing the operation of the read channel 116 during reading servo data on the magnetic disk medium when the MPU is performing positional control of the magnetic head in the magnetic recording apparatus equipped with magnetic disk medium of the present exemplary embodiment. FIG. 8 is an operation timing chart of the read channel 116.

The magnetic disk medium 1 is rotated at a fixed angular velocity to obtain a servo pattern reproduction signal (a) at fixed time intervals from the head amplifier. After high frequency noise components have been blocked by a low-pass filter 122 in the read channel 116 the servo pattern reproduction signal (a) is then A/D converted by an A/D converter 123. Variable gain 121 is then adjusted by a gain controller 125 based on the digitalized amplitude data so as to obtain the optimal amplitude.

Lead-in portions of the servo patterns are written with a fixed cycle pattern as the synchronization signal generating portions 21, such that a predetermined servo gate signal (b) is asserted to obtain sufficient wave number for a Phase Locked Loop (PLL) to converge.

When the servo gate signal (b) is asserted, the PLL is locked to the synchronization signal of the servo pattern reproduction signal, and an ADC clock signal (d), required for sampling the address portions and the precision position detection portions expressed by the servo pattern reproduction signal, is generated from a PLL circuit 124.

A servo sync mark pattern indicating the start of servo data is written at the trailing end of the synchronization signal generating portions of the servo patterns with either a fixed length bit or a characteristic code pattern bit. When this is detected a synchronization pattern detection signal (c) is asserted.

A synchronization signal detector 126 confirms assertion of the synchronization pattern detection signal (c), and then a reproduced address portion is demodulated by sending an address detection gate signal (e) to an address demodulator 127.

An address demodulation value (g) is identified when demodulation of a default length address portion has been completed, and the address demodulation value (g) is recorded as digital data in a register 129. This is followed by assertion of a burst gate signal (f), and demodulation of the precision position detection portions is started by a precision position demodulator 128.

When demodulation of the default length precision position detection portions has been completed a precision position demodulation value (h) is identified and recorded as digital data in a register 129.

The MPU 115 reads the address demodulation value (g) and the precision position demodulation value (h) stored in the registers by performing the above operations, performs computation for positional control of the magnetic head, and drives the VCM driver 112.

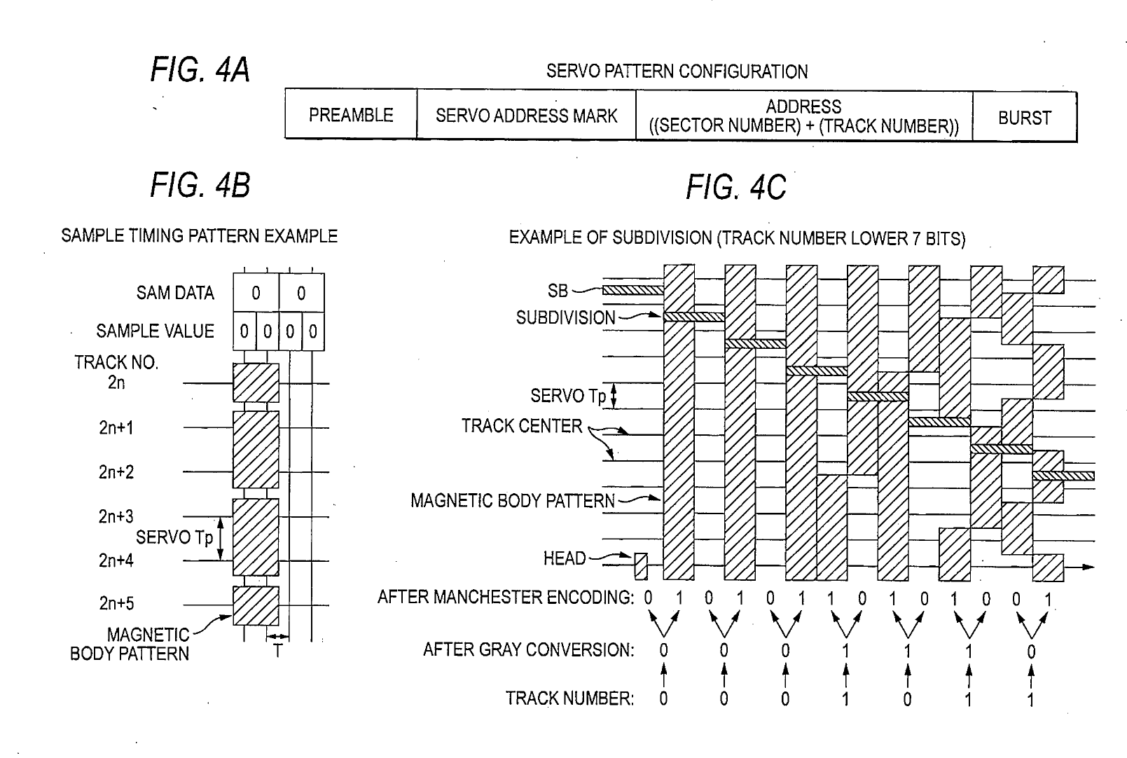

FIG. 4A is a summary of an example configuration of a servo pattern. After a preamble region for clock synchronization there is a Servo Address Mark (SAM) that acts as a reference timing for servo signal generation. This is followed by an address pattern indicating the sector number and the track number, and then a burst pattern for detecting the position of the head.

FIG. 4B illustrates an example of a SAM pattern in BPM. In BPM, a magnetic layer with strong exchange coupling between particles is employed such that dots behave as a single magnetic domain even when there are plural magnetic particles in a data track. This reduces the coercive force from a demagnetizing field in large surface area patterns such as a servo pattern, and sometimes there is spontaneous reversal of magnetization even when the magnetization direction has been initialized. In order to address this issue coercive force can be secured by making subdivisions to give a smaller surface area patterns for the servo pattern. In FIG. 4B the patterns have been divided at into subdivisions of 2× the servo pitch Tp.

However servo signal deterioration becomes an issue of in related examples adopting this approach. When the read head passes at the position of the subdivisions this results in a deterioration in the reproduction waveform amplitude. Accordingly a method is required that can correctly detect a servo pattern without being affected by such deterioration due to subdivision.

Subdivision of the address pattern in a similar manner to the SAM pattern is effective for preventing magnetic reversal of the address pattern. However, it is important to have a method for making subdivisions according to simple rules in address patterns in which their pattern changes according to the radial direction position (address code).

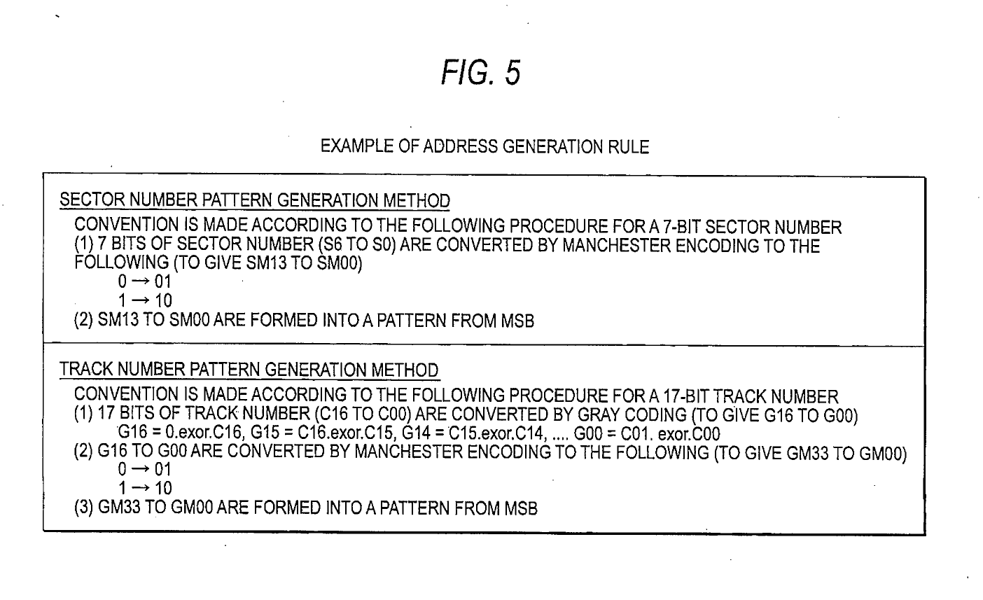

FIG. 5 is an example of rules for generating an address (sector number, track number). The track number is subject to Gray code conversion for convenience with seeking, however patterns of “1” and “0” on the medium are determined by Manchester encoding for both the sector number and the track number.

In the present exemplary embodiment the address pattern is subdivided by utilizing the characteristics of Manchester encoding.

FIG. 4C illustrates an example of an address pattern subdivision method in the present exemplary embodiment. The address pattern is subdivided in this example by repeating the following two processes.

(1) First division is made with a first single subdivision unit formed from the second bit of the two bits resulting from expanding the first single bit of the address code with Manchester encoding, combined with the first bit of the two bits resulting from expanding the next single bit of the address code.

(2) Then following on from (1) the next pattern is subdivided at a position that differs by a specific number of track pitches in the radial direction, by performing a similar operation.

FIG. 4C shows the non-magnetic patterns as white portions. The portions SB where subdivision is made is illustrated in a grey color, however the division portions are formed as non-magnetic portions physically the same as the non-magnetic patterns shown in white.

Due to the characteristics of Manchester encoding two types arise for the width of magnetic body patterns, when there is a “1”, and when there is a “11” formed by two “1”s next to each other. The location where a “11” appears only when the second bit of the two bits resulting from expanding a given single bit of the address code with Manchester encoding, and the first bit of the two bits resulting from expanding the next single bit of the address code with Manchester encoding, are both “1”.

Consequently, by performing subdivision as in (1) above, the entire width of both patterns of “1” and patterns of “11” are divided by subdivision according to simple rules, and cases do not arise where only a “1” of half a “11” width pattern is divided.

By sequentially shifting radial position for performing subdivision by a specific number of times the track pitch (for example 1×), as in (2), the influence from subdivisions when the head passes along a track to reproduce the address can be reduced.

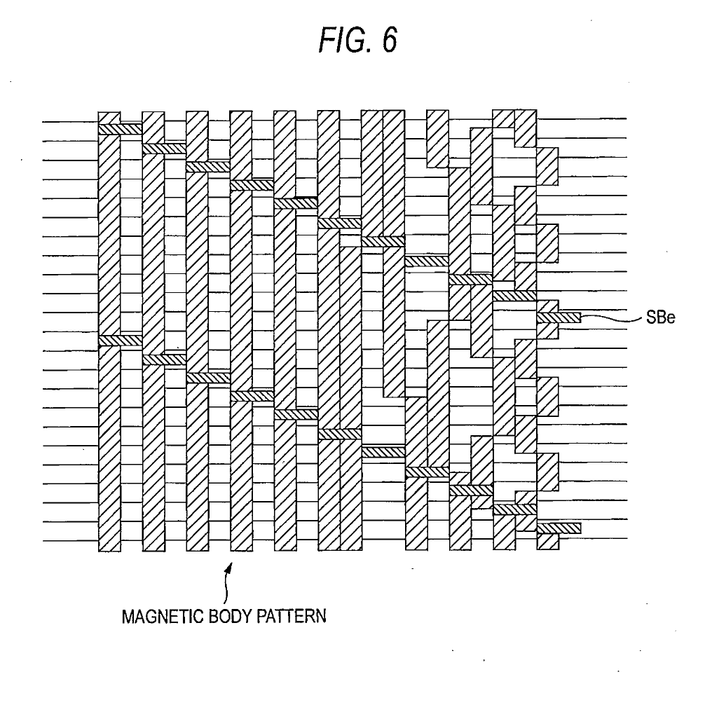

As shown in FIG. 6, the influence of the subdivisions when the head passes along a track to reproduce an address pattern can be limited to only a single location in the address code by returning to dividing at the first bit of the address code after repeatedly dividing as described above from the first to the last bit (SBe) of the address code.

The way in which subdivision of the address pattern is performed when there are the subdivision units of (1) is not limited to (2). For example, division may be made every 2× servo track pitch Tp in the radial direction so as to divide alternately in the circular circumferential direction.

Furthermore, since the coercive force of the small surface area lower order bit patterns is already intrinsically higher, there is less need to perform subdivision thereon. It is therefore possible to not subdivide the pattern in a range from the lowest order bit up to a specific bit.

According to the above exemplary embodiment, an address pattern that changes according to the address code can be subdivided using simple rules.

As a result a SAM can be correctly and reliably detected independently of the radial position where the read head passes, as explained in the above example.

More specifically, address patterns that change according to radial direction position can be subdivided according to the simple rules by the following method.

(1) In subdivision of an address pattern in the middle of a servo pattern of a bit patterned media, a single subdivision unit is formed from the second bit of the two bits resulting from expanding a given single bit of the address code with Manchester encoding, combined with the first bit of the two bits resulting from expanding the next single bit of the address code.

(2) The next pattern is subdivided at a position that differs by a specific number of track pitches in the radial direction, by repeating a similar operation.

(3) Such subdivision is performed repeatedly such that after the address code has been finally divided from the first bit to the last bit, subdivision is then again made to the first bit of the address code at a radial position that differs by a specific number of times the track pitch.

(4) Is the processing of (1) in which subdivision is not performed to the address pattern corresponding to bit (s) in a range from the lowest order bit up to a specific number of bits in the address code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a data region comprises a plurality of first magnetic dots disposed at specific positions for recording data; and
a servo region comprises a plurality of second magnetic dots disposed at specific positions for identifying the position of the first magnetic dots, wherein
an address pattern in the servo region is subdivided in the radial direction.

2. The magnetic recording medium of claim 1, wherein
the adjacent address patterns in the servo region are subdivided respectively at positions which differ from each other in the radial direction by a specific multiple of a track pitch.

3. The magnetic recording medium of claim 1, wherein
when subdividing the address pattern a single subdivision unit is a combination of a second bit of two bits resulting from expanding a single bit of the address code with Manchester encoding combined with a first bit of two bits resulting from expanding a next single bit of the address code with Manchester encoding.

4. A magnetic recording apparatus comprising:
a magnetic recording medium comprising: a data region including a plurality of first magnetic dots disposed at specific positions for recording data; and a servo region including a plurality of second magnetic dots disposed at specific positions for identifying the position of the first magnetic dots, wherein an address pattern in the servo region is subdivided in the radial direction; and
a magnetic head comprises an element disposed facing the surface of the magnetic recording medium for recording magnetic data to the magnetic recording medium and reproducing magnetic data on the magnetic recording medium.

5. The magnetic recording apparatus of claim 4, wherein
the adjacent address patterns in the servo region are subdivided respectively at positions which differ from each other in the radial direction by a specific multiple of a track pitch.

6. The magnetic recording apparatus of claim 4, wherein when subdividing the address pattern a single subdivision unit is a combination of a second bit of two bits resulting from expanding a single bit of the address code with Manchester encoding combined with a first bit of two bits resulting from expanding a next single bit of the address code with Manchester encoding.
